(19) United States
(12) Patent Application Publication
(10) Pub. No.: US 2008/0100873 A1
(43) Pub. Date: May 1, 2008

(54) INFORMATION PROCESSING DEVICE, IMAGE LOG MANAGEMENT DEVICE, AND IMAGE LOG MANAGEMENT SYSTEM

(75) Inventor: Kei Ohtsu, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/751,816

(22) Filed: May 22, 2007

(30) Foreign Application Priority Data
Oct. 31, 2006 (JP) 2006-295090

(51) Int. Cl. H04N 1/00

(52) U.S. Cl. 358/403

(57) ABSTRACT

There is provided an information processing device. The information processing device includes an image processing unit that performs processing on an image based on input information, a first transmit unit that transmits a partial image of a region specified as a priority region of the image processed by the image processing unit to an image log management device and a second transmit unit that transmits the processed image to the image log management device after the first transmit unit transmits the partial image to the image log management device.

### CROSS-REFERENCE TO RELATED APPLICATIONS

This application is based on and claims priority under 35 USC 119 from Japanese Patent Application No. 2006-295090 filed on Oct. 31, 2006.

### BACKGROUND

1. Technical Field

The present invention relates to an information processing device, an image log management device, and an image log management system.

2. Related Art

In recent years, information leakage has become a serious problem in business activities. Measures against information leakage through printing, scanning, facsimile transmission etc. are desired for image processing devices, such as printers, copy machines, facsimile devices, scanners, and multifunction devices performing two or more functions of the above devices. Responding to such a demand, a system for storing images output through printing or facsimile transmission as log information for a future search is proposed.

### SUMMARY

According an aspect of the invention, there is provided an information processing device. The information processing device includes an image processing unit that performs processing on an image based on input information, a first transmit unit that transmits a partial image of a region specified as a priority region of the image processed by the image processing unit to an image log management device and a second transmit unit that transmits the processed image to the image log management device after the first transmit unit transmits the partial image to the image log management device.

### BRIEF DESCRIPTION OF THE DRAWINGS

Exemplary embodiments of the present invention will be described in detail based on the following figures, wherein:

FIG. 1 is a view illustrating an example of a configuration of an image log management system;

FIG. 2 is a view illustrating an example of an internal configuration of a site management server;

FIG. 3 is a view illustrating an example of a template;

FIG. 4 is a view for describing an example of region information;

FIG. 5 is a view for describing an example of period information;

FIG. 6 is a view for describing extraction of a partial image from a log image;

FIG. 7 is a view illustrating an example of an internal configuration of a center management server;

FIG. 8 is a view illustrating an example of data stored in a template memory;

FIG. 9 is a view illustrating an example of log records stored in a log storage; and

FIG. 10 is a view schematically illustrating an example of a hardware configuration of a computer.

### DETAILED DESCRIPTION

Exemplary embodiments of the present invention will now be described with reference to the drawings.

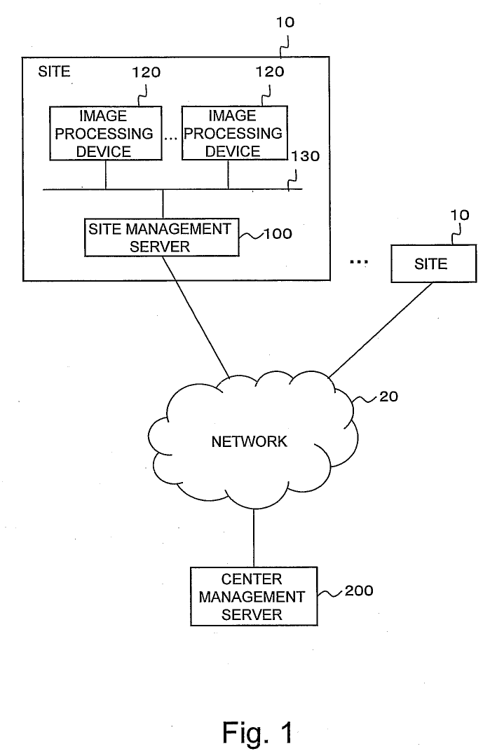

FIG. 1 illustrates an example of an embodiment of an image log management system. In this system, logs of image processing performed by image processing devices 120 disposed in one or more sites 10 are collected and managed by a center management server 200.

Image processing devices 120 include printers, scanners, digital copy machines, facsimile machines, digital multifunction devices having two or more functions of the above devices, and the like. Devices performing a process, such as color conversion, image quality adjustment, and character recognition, on image data also fall within the scope of the image processing device 120. Examples of image processing performed by the image processing device 120 include printing, image reading, copying, and facsimile transmission of the read image. The process of transmitting the read image through a network, such as Internet, is also within the scope of image processing. Such transmission can be achieved by using a transmission protocol, such as FTP (file transfer protocol) or attaching the file to an e-mail.

A site 10 is a facility where the image processing device 120 is disposed, such as an office or a store. One or more image processing devices 120 are disposed at the site 10. Such image processing devices 120 are connected to a network 130 at the site 10, such as LAN (local area network), and the network 130 is connected to a site management server 100. Each image processing device 120 transmits a log record related to image processing performed by itself to the site management server 100 through the network 130. The site management server 100 temporarily holds the log record of image processing performed by each image processing device 120. The site management server 100 is connected to a network 20, such as Internet, and transmits information of the temporarily held log record to a center management server 200 through the network 20.

The log record related to image processing includes a log image related to image processing in addition to conventional log information, which is recorded as the process log in conventional systems, such as time and date when image processing is performed and the type of image processing. The log image related to the image processing is an image produced or output through image processing, or an image used for image processing. For image processing, such as image reading, copying, facsimile transmission, etc. the image resulting from reading a paper document may be used as the log image. For image processing such as printing, the image produced from print data received from a client computer can be used as the log image. For image processing such as color conversion, the image subjected to, or resulting from, the process can be used as the log image. Alternatively, instead of using such an image itself, the result obtained by performing a predetermined process, such as image compression, on such an image can be used as the log image.

The center management server 200 is a device for managing a log record of image processing performed by each image processing device 120. The server 200 receives and stores, from the site management server 100, the log record related to image processing performed by each image processing device 120. The center management server 200 provides a function of searching the stored log records. Such a searching function may be used for specifying the source of leakage when a document is leaked. The log image may also be taken into consideration in addition to the log information, such as time and date, for such a search.

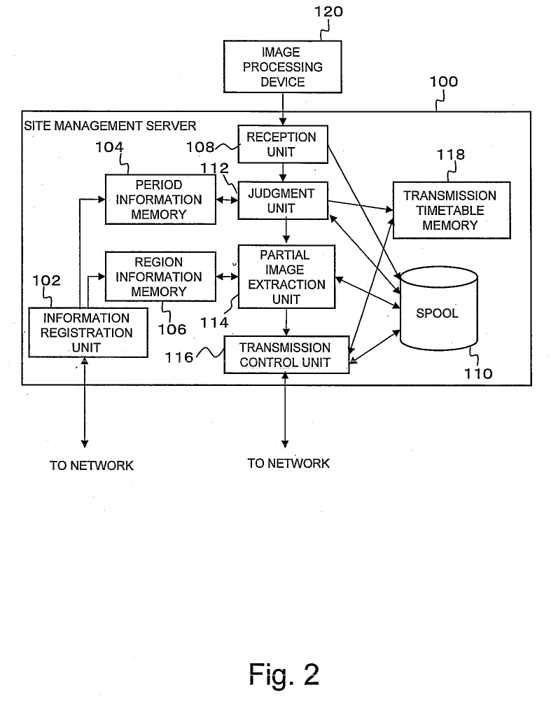

The site management server 100 will next be described in more detail with reference to FIG. 2. In the site management server 100, an information registration unit 102 performs a process for registering setting information used for controlling transmission of log information and log images to the center management server 200. Such setting information includes template information and information on a transmission permitted period. The template information includes a template image in a document processed by the image processing device 120, and region information defining a region to be preferentially registered with the center management server 200 selected from the document image (this region will be hereinafter referred to as “priority region”).

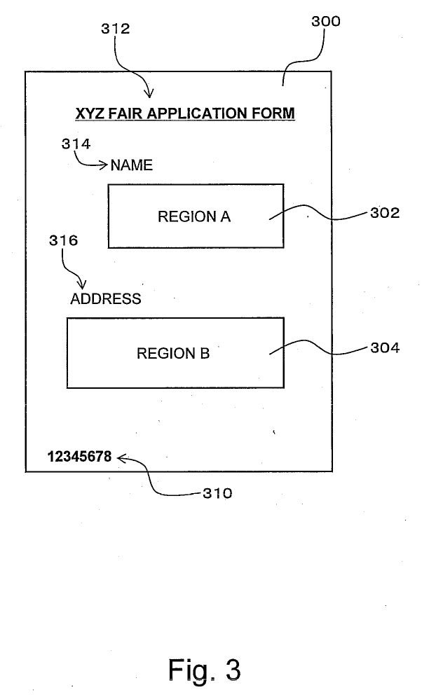

An example of template information will be described with reference to FIG. 3. FIG. 3 shows a template 300 of an application form for an event “XYZ fair”. Regions A302 and B304 are priority regions in this template 300. The regions A and B are for filling the name and address, respectively, of an applicant. While the regions A and B have a rectangular shape in this example, the shapes of the priority regions are not limited to rectangles. A template identifier image 310 is an image indicating an identifier (referred to as a template identifier) uniquely assigned to this template 300. The template identifier is an identifier uniquely assigned to each template handled in the image log management system. A variety of methods have been known for producing a unique identifier for the entire system in each device (the site management server 100 in this example) in the system. Such a conventional method can be used for producing the template identifier.

While in the example of FIG. 3 the image 310 of the template identifier has a value expressed in a number string, this is only an example. The template identifier value expressed as an image code, such as a one-dimensional or two-dimensional barcode, may be used as the template identifier image 310. An image code indicating the value of the template identifier may be embedded as a watermark in the template image. A heading 312 of the application form and headings 314 and 316 of the regions A and B, respectively, are template portions in the application form. In the filled-in application forms, images in the regions A and B are different for each application form. On the other hand, the portion excluding the regions A and B, such as the template identifier image 310 and the headings 312-316 are the same for all “XYZ fair” application forms. Such common portions are the template image.

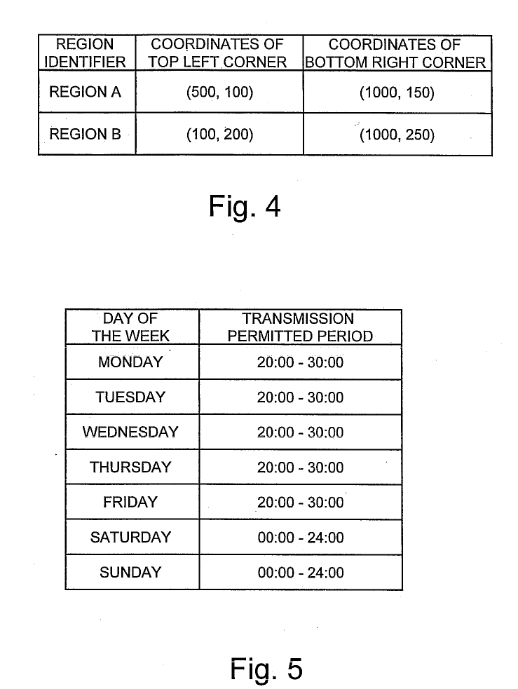

FIG. 4 shows an example of region information corresponding to the template 300 illustrated in FIG. 3 as an example. As illustrated, the region information of each priority region includes a region identifier for specifying the priority region of interest, and information indicating the position, shape and the like of the priority region in the template 300. Since the priority regions A and B have a rectangular shape in the example of FIG. 3, a combination of coordinates of the top left corner and the right bottom corner of the region are used as information specifying the position and shape of the priority region. This is merely an example, and any form of expression can be used as long as the position and shape of each priority region can be expressed.

The transmission permitted period information is the information indicating the time period during which transmission of the log images of each image processing device 120 in the site 10 accumulated in the site management server 100 to the center management server 200 is allowed.

The band of a communication channel between the site 10 and the center management server 200 (such as the channel band between the site 10 and an access point on the network 20) is limited. As a measure to effectively use the band, it is possible to avoid use of the band for transmission of the log record, particularly a large volume of log image data, as much as possible in a time period when the channel band must be saved for business communication, such as the business hours of the site 10. For example, the transmission permitted period may be defined based on the business hours of the site 10 (such as an office). In the example of FIG. 5, the transmission permitted period is from 8:00 p.m. to 6:00 a.m. the next morning on weekdays while on Saturday and Sunday transmission is permitted 24 hours a day. Note that defining the transmission permitted period based on business hours is merely an example, and that the period may be determined based on other standards.

The information registration unit 102 executes a process for registering the template information (including region information) and the transmission permitted period information described above with the site management server 100. For example, the site management server 100 provides an input mechanism for entry of a template image, and a UI (user interface) for receiving definition of the priority region on the template image from a user. The input mechanism of the template image may be a scanner for scanning a sample paper document. Alternatively, it may be a mechanism for receiving input of template image data produced by an application via a network, or a mechanism for reading a portable storage medium having the template image data stored therein. The UI for defining the priority region may be an interface for displaying a template image on a screen, and receiving designation of coordinates defining the priority region or a border line on the displayed image through a touch panel or the like. Naturally, such a UI is only an example.

Among the thus input template images and region information, the information registration unit 102 stores at least the region information in a region information memory 106. The information registration unit 102 may acquire the template image and region information produced by another device to store at least the region information in the region information memory 106. The information registration unit 102 assigns a template identifier that is unique within the system to the thus input template information (i.e. a pair of image and region information), and attaches an image of the template identifier to the template image. The above-described region information is registered with the region information memory 106 in association with the template identifier. In other words, the region information memory 106 stores, for each type of documents, the template identifier corresponding to that type of document and the region information, associated with each other.

The information registration unit 102 registers the input template information and the template identifier with the center management server 200 in association with each other, via the network 20.

The information registration unit 102 further includes a UI for setting the transmission permitted period, and stores 2b a table (see FIG. 5 for example) of the set transmission permitted period in a period information memory 104.

A reception unit 108 receives log information and log images from the image processing device 120 via the network 130. The received log information and log image are stored in a spool 110 in association with an identifier (hereinafter referred to as a “log identifier”) for identifying the log information and log image. The log identifier is used for identifying the log information and log image to be acquired from the spool 110. As the log identifier, a job identifier of an image processing job may be used. More specifically, when, for example, the image processing device 120 executes an image processing job and transmits the log information and log image related to the job to the site management server 100 in association with the job identifier uniquely assigned to the job, the log information and log image are stored in association with the job identifier in the spool 110. Alternatively, a unique identifier may be assigned to the log information and log image in the spool 110 and used as the log identifier. As the log identifier, an identifier uniquely used throughout the image log management system may be used. For this purpose, an identifier that is unique within the image processing device 120 or the site management server 100 and an identifier uniquely identifying the image processing device 120 or the site management server 100 within the system may be combined to produce a log identifier that is unique within the system. Because a hash value with a sufficient length obtained from the log image or the log identifier or the combined data of both through an algorithm, such as SHA-256, is sufficiently unique for practical use, such a hash value may be used as a unique log identifier in the system.

A judgment unit 112 judges whether or not the received log image is the image of the document formed by using the template. In this judgment, the log image is judged as being formed using the template if the template identifier image can be detected from the log image. The template identifier image may be detected in accordance with the method of embedding the template identifier image in the document image. For example, when the value of the template identifier is embedded as watermark information in the document image, the template identifier can be detected through a process of extracting the watermark information from the image. In addition, when the template identifier image is detected from the log image during the judgment process, the judgment unit 112 obtains the value of the template identifier indicated by the identifier image.

When the judgment unit 112 judges that the log image indicates the document was formed using the template, the unit 112 sends a process instruction including the value of the template identifier detected from the log image and the log identifier indicating the log image of interest in the spool 110 to a partial image extraction unit 114. The process performed by the partial image extraction unit 114 in response to the process instruction will be described later.

When the log image indicates a document formed using the template, the judgment unit 112 determines the scheduled transmission time at which a whole log image is transmitted to the center management server 200 based on the information of the transmission permitted period stored in the period information memory 104 and a transmission timetable stored in a transmission timetable memory 118, and registers the scheduled transmission time thus determined in the transmission timetable. The whole log image will be hereinafter referred to as a “whole image” while the image of the priority region extracted from the log image will be referred to as a “partial image” (description of the partial image will be given later) The scheduled transmission time for transmitting the whole image for each log image received by the site management server 100 is registered in the transmission timetable. The judgment unit 112 judges whether or not the current time at which the log image is received from the reception unit 108 falls within the transmission permitted period. If judged as falling within the transmission permitted period, the earliest unallocated time slot (i.e. the time slot that has not yet been allocated as the scheduled transmission time) from the current time is obtained from the transmission timetable, and the unallocated time slot is registered as the scheduled transmission time for transmitting the whole image of the log image in the transmission timetable. Since a certain amount of time is required for transmitting the log image, the estimated time period required for transmitting a single log image (whole image) is considered as one time slot in the timetable, and the scheduled transmission time can be designated on a slot by slot basis. If it is judged that the current time is not within the transmission permitted period when the log image is received from the reception unit 108, the judgment unit 112 may acquire the earliest unallocated time slot from the current time out of the unallocated time slots in the next transmission permitted period in the transmission timetable, and the unallocated time slot thus acquired is registered as the scheduled transmission time for the whole image in the transmission timetable.

Registration of the scheduled transmission time on the transmission timetable may be performed by associating the log identifier of the log image stored in the spool 110 with the time slot of the transmission timetable.

While the above description relates to the case in which the log image indicates the document formed using the template, if the log image indicates the document formed without using the template, the judgment unit 112 determines the scheduled transmission time for transmitting the whole image of the log image, and registers the time in the transmission timetable. In such a case, a process instruction will not be given to the partial image extraction unit 114. Registration of the scheduled transmission time in the transmission timetable can be performed similarly to the registration for the log image of the document formed using the template. To put it briefly, the scheduled transmission time may be determined as, for example, the earliest unallocated time slot from the current time if it is within the transmission permitted period, and as the earliest unallocated time slot in the next transmission permitted period otherwise.

The partial image extraction unit 114 extracts an image of the priority region from the whole image of the log image in response to the process instruction from the judgment unit 112. More specifically, the partial image extraction unit 114 acquires the log image corresponding to the log identifier specified in the process instruction from the spool 110, and retrieves from the region information memory 106 the region information corresponding to the template identifier specified in the process instruction. The unit extracts the image of the priority region indicated by the retrieved region information (i.e. “partial image”) from the acquired log image. The extracted partial image is then stored in the spool 110 in association with the log identifier.

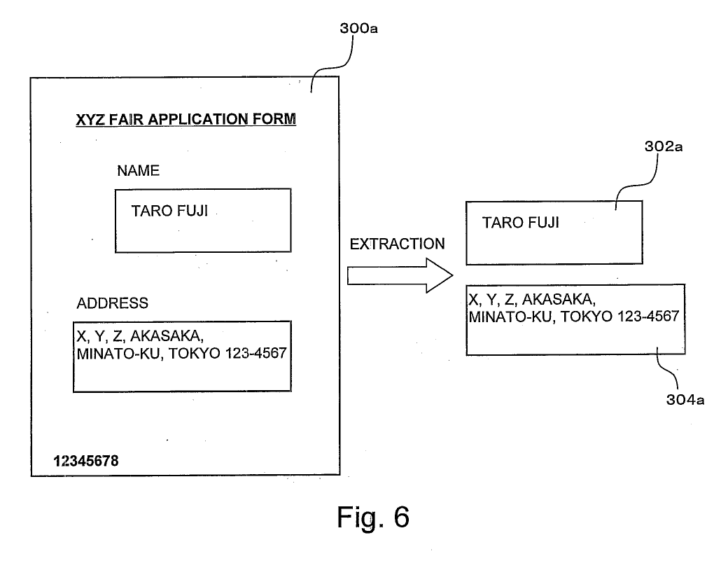

It is assumed here that the site management server 100 receives a log image 300a shown in FIG. 6 from the image processing device 120. The log image 300a is the image obtained by performing image processing on the application form, which is arranged based on the template 300 illustrated in FIG. 3, having the name and address filled therein. The partial image extraction unit 114 receives the log image 300a and information specifying priority regions 302 and 304 from the judgment unit 112, and extracts partial images 302a and 304a of the respective priority regions from the log image 300a. The partial image extraction unit 114 stores the partial images 302a and 304a in the spool 110 in association with the log identifier of the log image 300a. Each of the partial images 302a and 304a stored in the spool 110 is associated with the corresponding region identifier.

After extracting the partial image and registering it with the spool 110, the partial image extraction unit 114 transmits a priority transmission instruction including the log identifier of the log image 300a and the template identifier to a transmission controller 116.

The transmission controller 116 controls a process of transmitting the log information and log image to the center management server 200. When a priority transmission instruction is received from the partial image extraction unit 114, the transmission controller 116 acquires the partial image and attribute information corresponding to the log identifier included in the instruction from the spool 110. The transmission controller 116 then transmits the acquired partial image and attribute information and the template identifier included in the instruction to the center management server 200 through the network 20. The transmitted partial image is associated with the region identifier identifying the priority region where the partial image is located before transmission. The log information and partial image thus transmitted may be deleted from the spool 110. Alternatively, rather than deleting the transmitted log information and partial image, information indicating that the log information and partial image have already been transmitted may be registered with the spool 110. Information indicating that such deletion or transmission is complete may be registered after receiving a response from the center management server 200 indicating that the transmitted information is successfully stored.

The transmission controller 116 may regularly refer to the transmission timetable memory 118. If the log identifier for which the scheduled transmission time has come is found as a result of reference, the controller retrieves the log information or the log image (whole image) corresponding to the log identifier, or both thereof, from the spool 110, and transmits it to the center management server 200. When the log information has already been transmitted together with the partial image, only the whole image is transmitted. For such transmission, the log information or the whole image is transmitted in association with the log identifier.

In the above-described control performed by the transmission controller 116, if a log record is generated for the document formed using the template at the time outside the transmission permitted period, the partial image and the log information are rapidly transmitted to the center management server 200. For the whole image of the document formed using the template or the log record of the document formed without using the template, transmission is performed rapidly to the center management server 200 if it is generated within the transmission permitted period, or rapidly after the next transmission permitted period has come if it is outside the transmission permitted period. Since the log information portion of date and the like in the log record for the document formed without using the template has a small volume of data compared with the log image, this portion may be rapidly transmitted to the center management server 200 even outside the transmission permitted period.

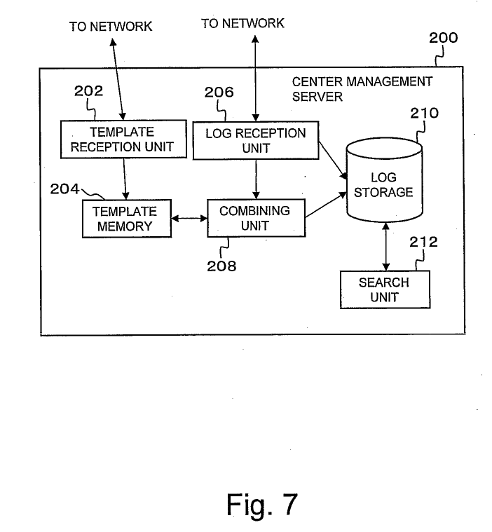

Following the above description of an example of the site management server 100, an example of the center management server 200 will next be described with reference to FIG. 7.

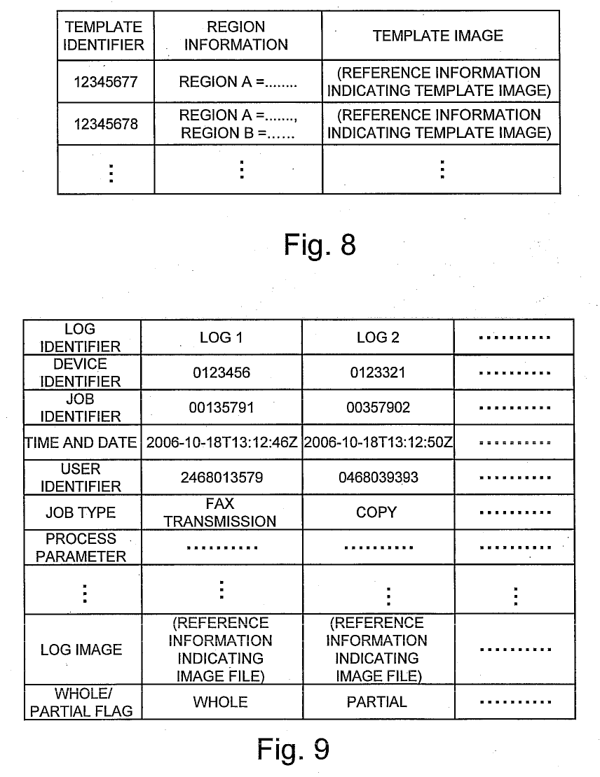

In the center management server 200, a template reception unit 202 stores the template identifier and template information (a pair of template image and region information) transmitted from the information registration unit 102 of the site management server 100 in a template memory 204 in association with each other. An example of data stored in the template memory 204 is shown in FIG. 8. As illustrated in FIG. 8, the region information and the template image are registered with the template memory 204 in association with the template identifier. The region information includes, for each priority region included in the template, the region identifier of the priority region and information indicating the position and shape of the priority region. While the template memory 204 stores reference information indicating the template image stored in a storage device accessible from the center management server 100 in the illustrated example, this is only an example, and the image data of the template image itself may be stored in the template memory 204.

A log reception unit 206 receives log information, a partial image, and a whole image transmitted from the transmission controller 116 of the site management server 100 via the network 20. When the log information and a whole image are received, the log reception unit 206 registers them with a log storage 210 in association with the log identifier. When a partial image and the template identifier corresponding thereto are received, the log reception unit 206 passes these elements to a combining unit 208.

The combining unit 208 acquires the template image and the region information corresponding to the template identifier from the template memory 204, and combines the corresponding partial image with each priority region on the template image. The position and shape of each priority region can be obtained from the region information. Through such a combination process, partial images 302a and 304a as illustrated in FIG. 6, for example, are combined to the image of the template 300 as shown in FIG. 3. The combined image obtained by such a combination includes the image acquired from the actual log image for the priority region. The combining unit 208 registers the combined image thus produced with the log storage 210 in association with the log identifier.

An example of log records stored in the log storage 210 is shown in FIG. 9. In this example, each log record includes a log identifier, a device identifier, a job identifier, time and date, a user identifier, a job type, a process parameter, a log image, and a whole/partial flag. The device identifier is the identifier of the image processing device 120 that has executed the image processing job related to the log record of interest, and the job identifier is the identifier of the image processing job. Time and date are the time and date when the image processing job is executed, and the user identifier identifies the user who instructed execution of the job. The job type is the type of the process contents of the job. The job types may include copying, printing, scanning, and facsimile transmission. The process parameter is the process parameter used for executing the image processing job. For example, the process parameter for facsimile transmission may be the fax number of the destination. While reference information indicating the location where an image file of the log image is stored is used as the log image data in the illustrated example, this is only an example. The log image stored in the log storage 210 may be a whole image or a combined image of a partial image and a template image. The whole/partial flag is flag information for indicating whether the stored log image is a whole image or a combined image produced from a partial image.

When a whole image is received from the site management server 100 and a combined image corresponding to the whole image has already been stored in the log storage 210, the log reception unit 206 stores the whole image replacing the combined image, and switches the whole/partial flag from “partial” to “whole”.

The items of the log record illustrated in FIG. 9 are only examples. The log record may not include all of the illustrated items, and may include other items.

A search unit 212 is a function module for searching and retrieving the log record stored in the log storage 210. The search unit 212 may provide a user interface for entry of search conditions, and provide a user with the log record matching the search conditions entered through the user interface. The search unit 212 may display the log image in the retrieved log record. In such a case, the search unit 212 may determine whether the displayed log image is a whole image or a combined image produced from a partial image based on the whole/partial flag, and display the determination result together with the log image. An administrator operating the center management server 200 may check the log record using the search unit 212. The log record including the log image may be retrieved using various well-known methods.

In the system illustrated above, the image processing device 120 receives an image processing instruction from a user, and, after executing the image processing, produces and transmits to the site management server 100 a log record including a log image and log information related to the image processing. For this action, the image processing device 120 may be controlled so as not to output the result of image processing until a response indicating that the log record is successfully received arrives from the site management server 100. For duplication, for example, a log image can be produced once a document is scanned. Therefore, the image processing device 120 may transmit the log image and log information to the site management server 100, suspend printing of the read image onto a sheet until receiving a response confirming the receipt, and print the image to the sheet after the reception. Also in other processes, such as facsimile transmission and storage of the read image, outputting processes, such as transmission and storage, may be suspended until a response confirming the receipt of the log record is received from the site management server 100.

While determination as to whether or not a whole image can be transmitted is made based on information of the transmission permitted period in the above example, it should be understood that similar determination can be made using information on the period during which transmission is not permitted. Alternatively, such period information may be replaced by determination conditions or determination algorithms for determining whether or not transmission is permitted.

Although a non-template, i.e. unfixed, portion in a document is used as a priority region in the above description, this is only an example, and a region including a template portion in the document image may be used as the priority region.

In the above example, when a partial image of the log image is received from the site management server 100, the center management server 200 combines it with a template image to be stored in the log storage 210. This is, however, only an example, and the partial image may be directly stored in the log storage 210 without being combined with the template image.

Further, in the above example, when the center management server 200 receives a whole image after storing a combined image based on the corresponding partial image in the log storage 210, the server deletes the combined image in the log storage 210 and stores the whole image instead. However, this is only an example, and the combined image may not be deleted and the whole image may be stored in addition thereto.

While the log record produced by the image processing device 120 is transmitted to the center management server 200 via the site management server 100 in the above example, this is only an example. Instead of providing the site management server 100, the log record can be directly transmitted from the image processing device 120 to the center management server 200. In such a case, the image processing device 120 may be provided with the function of the above-described site management server 100.

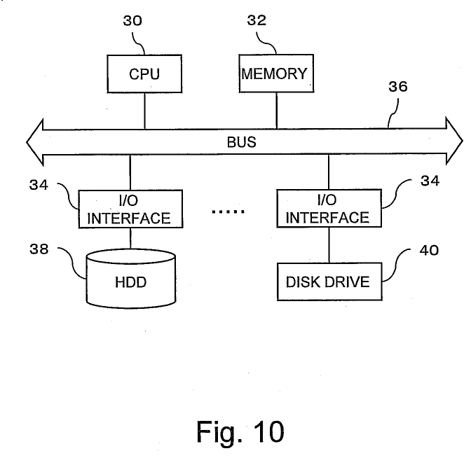

The above-described site management server 100 and center management server 200 are typically implemented by executing a program having the above-described process contents and functions of the respective units described therein with a computer. The computer may have a circuit configuration including as hardware a CPU (central processing unit) 30, a memory (primary storage) 32, and a variety of I/O (input/output) interfaces 34 connected via a bus 36, as shown in FIG. 10. A hard disk drive 38 and a disk drive 40 for reading portable non-volatile storage media according to various standards, such as CDs, DVDs, and flash memories, are connected to the bus 36 via, for example, the I/O interface 34. Such a drive 38 or 40 functions as a storage device external to the memory. The program having the process contents in accordance with the embodiments described therein is stored in a fixed storage device such as the hard disk drive 38 or a non-volatile storage device in other styles through a storage medium, such as a CD and a DVD, or through a network, and installed in the computer. The program stored in the fixed storage device is loaded into the memory and executed by the CPU, thereby implementing the process of the embodiments.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device, comprising:
an image processing unit that performs processing on an image based on input information;
a first transmit unit that transmits a partial image of a region specified as a priority region of the image processed by the image processing unit to an image log management device; and
a second transmit unit that transmits the processed image to the image log management device after the first transmit unit transmits the partial image to the image log management device.

2. The information processing device according to claim 1, wherein
the second transmit unit transmits the processed image at time which is set in advance.

3. The information processing device according to claim 1, wherein
the second transmit unit transmits the processed image at other than time which is set in advance.

4. A computer readable medium storing a program causing a computer to execute a process for transmitting an image related to image processing to an image log management device, the process comprising:
performing image processing on an image based on input information;
transmitting a partial image of a region specified as a priority region of the image on which the image processing is performed to the image log management device; and
transmitting the image on which the image processing is performed to the image log management device after the partial image is transmitted to the image log management device.

5. An image processing method, comprising:
performing image processing on an image based on input information;
transmitting a partial image of a region specified as a priority region of the image on which the image processing is performed to the image log management device; and
transmitting the image on which the image processing is performed to the image log management device after the partial image is transmitted to the image log management device.

6. The image processing method according to claim 5, wherein
the image on which the image processing is performed is transmitted at time which is set in advance.

7. The image processing method according to claim 5, wherein
the image on which the image processing is performed is transmitted at other than time which is set in advance.

8. An image log management device, comprising:
a storage that stores a log image related to image processing performed by an image processing unit; and
a registration unit that receives a partial image of the log image from the image processing unit, registers the partial image as a temporary log image with the storage, receives, after registering the partial image with the storage, the log image corresponding to the partial image, and registers the received log image with the storage in place of the partial image.

9. The image log management device according to claim 8, wherein
when the partial image is received, the registration unit registers a combined image produced by combining the partial image and a template image corresponding to the partial image with the storage.

10. A computer readable medium storing a program causing a computer to execute a process for registering a log image related to image processing, the process comprising:
receiving a partial image of the log image related to the image processing performed by an image processing unit, and storing the partial image as a temporary log image in a storage; and
after registering the partial image of the log image with the storage, receiving the log image corresponding to the partial image, and registering the received log image with the storage in place of the partial image.

11. The computer readable medium according to claim 10, wherein
storing the partial image as a temporary log image in the storage includes storing a combined image produced by combining the partial image and a template image corresponding to the partial image in the storage.

12. An image log management system, comprising
an information processing device and an image log management device, wherein
the information processing device includes
an image processing unit that performs processing on an image based on input information,
a first transmit unit that transmits a partial image of a region specified as a priority region of the image processed by the image processing unit to an image log management device, and
a second transmit unit that transmits the processed image to the image log management device after the first transmit unit transmits the partial image to the image log management device, and
the image log management device includes
a storage that stores the image received from the information processing device, and
a registration unit that receives the partial image from the first transmit unit of the information processing device, registers the partial image as a temporary log image with the storage, and registers the image received from the second transmit unit with the storage in place of the partial image.
